(19) United States
(12) Patent Application Publication
(10) Pub. No.: US 2009/0116645 A1
(43) Pub. Date: May 7, 2009

(54) FILE SHARING METHOD AND SYSTEM USING ENCRYPTION AND DECRYPTION

(76) Inventors: Ikrae JEONG, Kwangju (KR); Dowon HONG, Daejeon-city (KR); Kyoil CHUNG, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/252,456

(22) Filed: Oct. 16, 2008

(30) Foreign Application Priority Data
Nov. 6, 2007 (KR) 10-2007-0112469

(51) Int. Cl. H04L 9/12; H04L 9/00; H04L 9/28

(52) U.S. Cl. 380/259; 380/28

(57) ABSTRACT

Disclosed is a file sharing method and system using encryption and decryption. A client hashes keywords related to files using a symmetric key algorithm, and encodes the hashed keywords. Then, the client encodes the files using the hashed keywords, and uploads to a file sharing server a ciphertext D including an encoded file m and the encoded keywords KW₁, . . . , KWₙ. In order to download a desired file, the client transmits to the file sharing server a query Q derived from the hashed keyword KW related to the desired file. The client receives from the file sharing server a set S_{D} of ciphertexts created from the same keyword as that queried, decodes the keyword, and decodes the file m using the decoded keyword KW.

### RELATED APPLICATIONS

The present application claims priority to Korean Patent Application Serial Number 10-2007-0112469, filed on Nov. 6, 2007, the entirety of which is hereby incorporated by reference.

### BACKGROUND OF THE INVENTION

1. Field of the Invention

The present invention relates to a file sharing method and system capable of ensuring privacy.

This work was supported by the IT R&D program of MIC/IITA [2005-Y-001-03, Developments of Next Generation Security Technology].

2. Description of the Related Art

In general, file sharing systems, such as Napster and Gnutella, are classified into a centralized system and a decentralized system.

In the centralized file sharing system, a central server is provided, such that user terminals can upload files to the central server and/or download files from the central server.

In the decentralized filing sharing system, no central server is provided, but instead a user terminal downloads files from other user terminals through a P2P network.

Most of the current research has focused on providing a file sharing system that allows users to be anonymous along with ensuring anonymity and integrity of a file.

That is, the file sharing system allows anonymity as an option for a user who wants to share his or her files with other users, but does not want his or her ID to be seen. Examples of the file sharing system that allows anonymity include a Freenet system and a Tarzan system.

The file sharing system can also ensure integrity of files, which prevents the file uploaded from a user from being changed without the user's agreement. The Freenet system uses a throwaway public key to ensure the integrity of a file.

An encoded keyword search technique is used for a private storage system and a message transfer system.

In the private storage system, a user searches his or her own files stored in a storage unit. Therefore, when a private storage system is used by a user, a file sharing system is not needed for other users to search the files.

In the message transfer system, a message sender needs to know a message receiver beforehand. Therefore, the message transfer system cannot be used as a file sharing system because the file sharing system cannot know a user who will download the file. The private storage system and the message transfer system are different from the file sharing system in the above respect. Therefore, an encoded keyword search technique for the file sharing system is needed.

Further, the user generally uploads a file and a keyword to the file sharing system for file sharing. In order to download a desired file from the file sharing system, a user terminal transmits a specific keyword query to the file sharing system. Then, the file sharing system provides the search result to the user terminal in response to the query from the user terminal, and transmits to the user terminal the files related to the keyword requested by the user terminal.

However, since, with the current file sharing systems, the content of the files downloaded and/or uploaded to or from the user terminals can be publicly known, confidentiality is not ensured. As a result, users' privacy is not completely ensured.

### SUMMARY OF THE INVENTION

The invention has been finalized in view of the drawbacks. An object of the invention is to provide a file sharing method and system using encryption and decryption capable of ensuring that the users' files and keywords are kept confidential and improving users' privacy.

In order to achieve the object, according to an aspect of the invention, there is provided a file sharing client system using encryption and decryption. The system includes: a keyword hashing unit that hashes keywords related to a file to be uploaded or downloaded; a keyword encoder that encodes the keyword which is related to the file to be uploaded and is hashed by the keyword hashing unit, using a symmetric key algorithm; a file encoder that uses the symmetric key algorithm to encode the file to be uploaded with the hashed keyword received from the keyword hashing unit; and a first data transmitting/receiving unit that uploads, to a file sharing server, a ciphertext including the keyword encoded by the keyword encoder and the file encoded by the file encoder.

The system further includes a query requesting unit that outputs a query derived from the keyword that is related to the file to be downloaded and is hashed by the keyword hashing unit.

The first data transmitting/receiving unit may transmits the query received from the query requesting unit to the file sharing server, and downloads a set of ciphertexts from the file sharing server.

The system further includes a keyword decoder that decodes the keyword included in the set of ciphertexts using the symmetric key algorithm; and a file decoder that decodes the encoded file included in the set of ciphertexts using the keyword decoded by the keyword decoder through the symmetric key algorithm.

The keyword hashing unit may secondarily hash the keyword, and transmit the hashed keyword to the keyword encoder, the file encoder, and the query requesting unit.

According to another aspect of the invention, there is provided a file sharing server system using encryption and decryption. The system includes: a second data transmitting/receiving unit that receives, from a client, a ciphertext including an encoded file and an encoded keyword, and a query derived from a keyword related to a file to be downloaded, and transmits a set of ciphertexts to the client; and a storage unit that stores the ciphertext received from the second data transmitting/receiving unit in a table.

The system further includes a query response processing unit that extracts, from the storage unit, the set of ciphertexts created from the same key as that related to the query Q received from the second data transmitting/receiving unit, and transmits the extracted set to the second data transmitting/receiving unit.

The system further includes a control unit that controls the second data transmitting/receiving unit, the storage unit, and the query response processing unit.

According to still another aspect of the invention, there is provided a file sharing method using encryption and decryption. The method includes: allowing a file sharing server to receive a ciphertext including an encoded file and an encoded keyword from a client; allowing the file sharing server to store the ciphertext in a table of a storage unit; and allowing the file sharing server to receive, from the client, a query derived from a keyword related to a file to be downloaded.

The method further includes allowing the file sharing server to extract, from the storage unit, a set of ciphertexts created from the same keyword as that related to the received query, and transmit the extracted set to the client.

According to yet another aspect of the invention, there is provided a file sharing method using encryption and decryption. The method includes: allowing a client to hash a keyword related to a file to be uploaded; allowing the client to encode the hashed keyword using a symmetric key algorithm; allowing the client to encode the file to be uploaded using the hashed keyword; and allowing the client to upload a ciphertext including the encoded keyword and the encoded file to a file sharing server.

The method further includes allowing the client to transmit, to the file sharing server, a query derived from a keyword related to a file to be downloaded.

The method further includes allowing the client to download a set of ciphertexts from the file sharing server, decode the keyword included in the set of ciphertexts using the symmetric key algorithm, and decode the encoded file included in the set of ciphertexts using the decoded keyword through the symmetric key algorithm.

The uploading of the ciphertext includes: selecting a random number R and a hashed keyword kₘ that is used as a symmetric key for encoding the file; generating a symmetric key kᵢ for encoding the hashed keyword kₘ using the hashed value of a keyword KW and the random number R; encoding the hashed keyword kₘ using the symmetric key kᵢ to generate an encoded keyword cᵢ; encoding the file to be uploaded using the hashed keyword kₘ to generate an encoded file c; and uploading the ciphertext including the encoded keyword cᵢ and the encoded file c to the file sharing server.

In the transmitting of the query to the file sharing server, the keyword related to the file to be downloaded is secondarily hashed to derive the query.

As described above, according to the invention, it is possible to ensure the confidentiality of users' files and keywords and improve users' privacy.

Further, only the symmetric key coding/decoding algorithm is used to upload and download files to or from the file sharing server. Therefore, there is minute difference in the amount of computation between the file sharing system and method according to the invention and the file sharing technique according to the related art.

### BRIEF DESCRIPTION OF THE DRAWINGS

FIG. 1 is a diagram illustrating the structure of a file sharing system using a symmetric key algorithm according to an embodiment of the invention;

FIG. 2 is a diagram illustrating the internal structure of a client and a file sharing server using the symmetric key algorithm according to the embodiment of the invention;

FIG. 3 is a flowchart illustrating a file sharing method using the encoding and decoding of a symmetric key algorithm to ensure privacy according to another embodiment of the invention; and

FIG. 4 is a diagram illustrating file upload and download protocols between a client and a file sharing server using a symmetric key algorithm according to an embodiment of the invention.

### DESCRIPTION OF THE PREFERRED EMBODIMENTS

Hereinafter, exemplary embodiments of the invention will be described in detail with reference to the accompanying drawings.

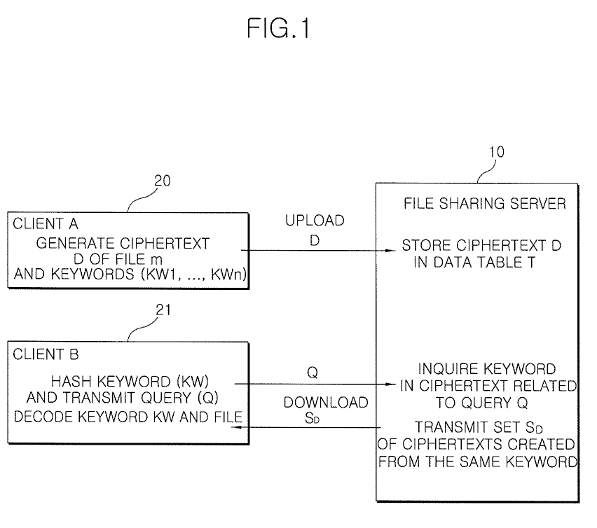

FIG. 1 is a diagram illustrating the structure of a file sharing system using a symmetric key algorithm according to an embodiment of the invention.

The file sharing system using a symmetric key coding/decoding algorithm according to the embodiment of the invention includes a plurality of clients 20 and 21 and a file sharing server 10.

The clients 20 and 21 use the symmetric key algorithm to hash keywords related to a file and encode the hashed keywords. A file m is encoded with the hashed keywords. A ciphertext D in which the file m and the keywords KW₁, KWₙ are encoded, is uploaded to the file sharing server 10 and then stored therein.

The clients 20 and 21 transmit to the file sharing server 10 a query Q derived from the hashed keyword KW that is related to a file to be downloaded. A set S_{D} of ciphertexts created from the same keyword as the queried keyword is downloaded from the file sharing server 10. Then, the symmetric key algorithm is used to decode the keyword, and the decoded keyword is used to decode the downloaded encoded file.

The file sharing server 10 stores in a data table T the ciphertext D received from the clients 20 and 21, in which the file m and the keywords KW₁, . . . , KWₙ are encoded. When receiving the query Q derived from the hashed keyword that is related to the file to be downloaded from the client, the file sharing server 10 inquires the keyword of the ciphertext related to the queried keyword, and transmits to the clients 20 and 21 a set S_{D} of ciphertexts created from the same keyword as the keyword related to the query.

The symmetric key algorithm uses one key, serving as both an encryption key and a decryption key, to encode or decode the file m (plaintext), and uses any one of the following standards: a DES (Data Encryption Standard, 64 bit), a 3DES (Triple DES), AES (Advanced Encryption Standard; a variable key length of 128 bit and 256 bit), and a SEED.

The symmetric key algorithm used in the clients 20 and 21 of the user terminals secondarily hashes the keyword related to the file, and uses the hashed keyword as an encryption key for a file to be uploaded and a decryption key for a file to be downloaded.

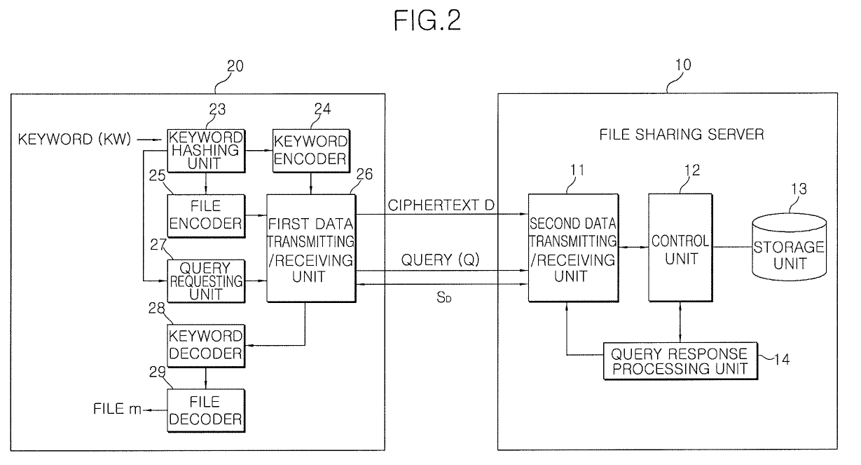

FIG. 2 is a diagram illustrating the internal structure of the file sharing server and the client using the symmetric key algorithm according to the embodiment of the invention.

The clients 20 and 21 each include a keyword hashing unit 23, a keyword encoder 24, a file encoder 25, a first data transmitting/receiving unit 26, a query requesting unit 27, a keyword decoder 28, and a file decoder 29.

The symmetric key algorithm used in the clients 20 and 21 uses the hashed keyword related to the file as an encryption key for the file to be uploaded and a decryption key for the file to be downloaded.

The keyword hashing unit 23 secondarily hashes the keywords related to the file to be uploaded using the equation h₀=H(KW); h₁=H(h₀).

The keyword encoder 24 uses the symmetric key algorithm to encode the keyword related to the file to be uploaded which is hashed by the keyword hashing unit.

The file encoder 25 uses the symmetric key algorithm to encode the film m to be uploaded using the hashed keyword that is received from the keyword hashing unit 23.

The first data transmitting/receiving unit 26 uploads the ciphertext D including the keyword encoded by the keyword encoder 24 and the file encoded by the file encoder 25 to the file sharing server, transmits the query Q received from the query requesting unit to the file sharing server, and downloads a set S_{D} of ciphertexts from the file sharing server.

The query requesting unit 27 transmits the query Q derived from the keyword that is hashed by the keyword hashing unit 23 to the file sharing server 10 through the first data transmitting/receiving unit 26 in order to download a desired file.

The keyword decoder 28 downloads from the file sharing server 10 the set S_{D} of ciphertexts created from the same keyword as the queried keyword, and uses the symmetric key algorithm to decode the keyword included in the set S_{D} of ciphertexts.

The file decoder 29 decodes the encoded file included in the downloaded set S_{D} of ciphertexts into the original file, using the keyword that is decoded by the symmetric key algorithm.

The file sharing server 10 includes a second data transmitting/receiving unit 11, a control unit 12, a storage unit 13, and a query response processing unit 14.

The second data transmitting/receiving unit 11 receives the ciphertext D including the encoded file and the encoded keyword from each of the clients 20 and 21. The second data transmitting/receiving unit 11 receives the query Q derived from the keyword related to a file to be downloaded from the client 21, and transmits the set S_{D} of ciphertexts to the client 21.

The control unit 12 is connected to the second data transmitting/receiving unit 11, the storage unit 13, and the query response processing unit 14, and controls the uploading, question and answer, and downloading of encoded files.

The storage unit 13 stores the ciphertext D including the received encoded file and encoded keyword in the data table T.

The query response processing unit 14 extracts from the storage unit 13 the set S_{D} of ciphertexts created from the same keyword as that related to the query Q received from the second data transmitting/receiving unit 11, and transmits the extracted set of ciphertexts to the client 21 through the second data transmitting/receiving unit 11.

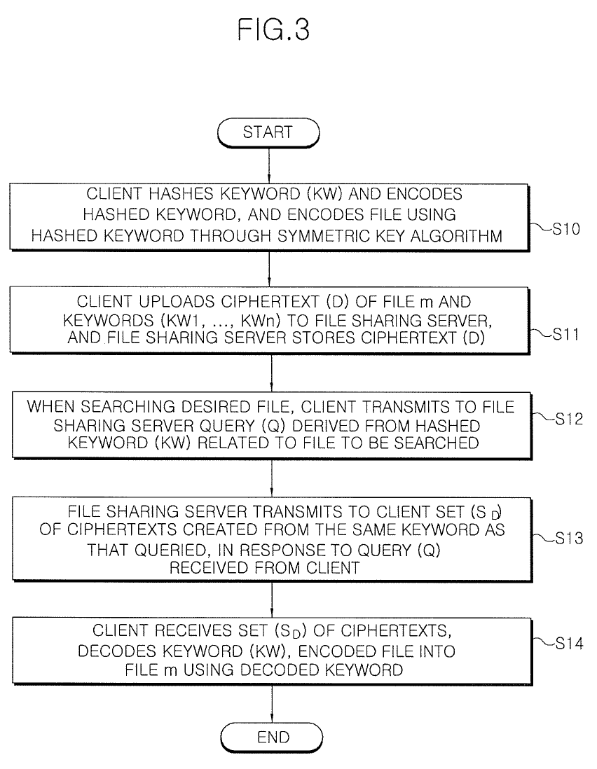

FIG. 3 is a flowchart illustrating a file sharing method using the encoding and decoding of a symmetric key algorithm ensuring privacy according to an embodiment of the invention.

The clients 20 and 21 each hash the keywords related to files to be uploaded and use the symmetric key algorithm to encode the hashed keywords. In addition, the clients 20 and 21 each encode the files to be uploaded with the hashed keywords, and upload the ciphertext D in which the file m and the keywords KW₁, . . . , KWₙ are encoded, to the file sharing server 10 (S10).

The file sharing server 10 stores the ciphertext D in which the file m and the keywords KW₁, . . . , KWₙ are encoded, received from each of the clients 20 and 21 in the data table T (S11).

The client 21 transmits the query Q derived from the hashed keyword related to a file to be downloaded to the sharing server 10 to inquire the keyword of the ciphertext stored in the data table (S12).

The file sharing server 10 searches the same keyword as the hashed keyword relating to the file to be downloaded and the keyword in the ciphertext stored in the data table T in response to the query, and transmits the set S_{D} of ciphertexts created from the same keyword as that queried to the client 21 (S13).

The client 21 receives the set S_{D} of ciphertexts created from the same keyword as that queried from the file sharing server 10, and decodes the keyword KW using the symmetric key algorithm. In addition, the client 21 decodes the encoded file to the file m, using the decoded keyword (S14).

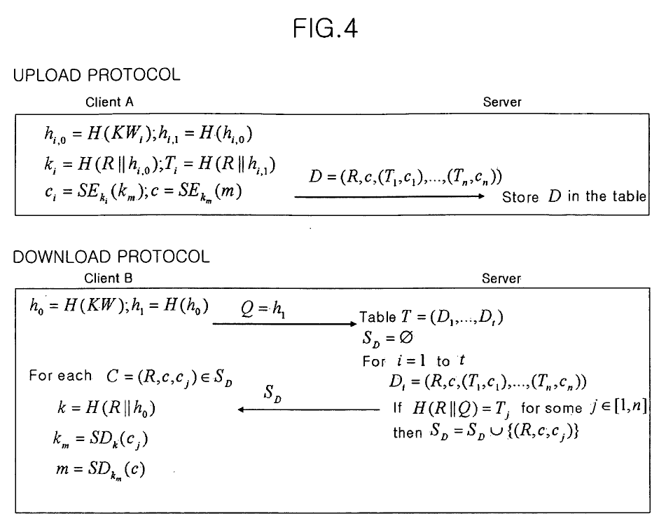

FIG. 4 is a diagram illustrating file upload and download protocols between a client and a file sharing server using a symmetric key algorithm according to an embodiment of the invention.

The file sharing method according to the embodiment of the invention includes an upload protocol and a download protocol. In the upload protocol, the client 20 hashes a keyword and encodes the hashed keyword. Then, the client 20 uses the symmetric key algorithm to encode a file with the hashed keyword, and uploads a ciphertext of the encoded file and keyword to the file sharing server 10. The download protocol is used to query the file sharing server 10 using the hashed keyword related to a file to be downloaded, thereby downloading a desired file from the file sharing server 10. According to the download protocol, the client 20 receives from the file sharing server 10 the set S_{D} of ciphertexts created from the same keyword as that queried by the client 20, decodes the keyword, and uses the decoded keyword to decode the file.

It is defined that H is a hash function and E=(SE,SD) is a symmetric cipher scheme.

The upload protocol of the file sharing system is performed through the following processes (1) to (4).

Each of the clients 20 and 21 hashes keywords related to a file to be uploaded and encodes the hashed keywords using the symmetric key algorithm. At the same time, the client encodes the file to be uploaded using the keywords through the symmetric key algorithm, and uploads the ciphertext D including the encoded keywords KW1, . . . , KWn and the encoded file m to the file sharing server 10. Then, the file sharing server 10 stores the received ciphertext.

(1) Each of the clients 20 and 21 selects a random number R and the hashed keyword kₘ that is used as a symmetric key for encoding a file to be uploaded.

(2) Under the condition 1≦i≦n, h_{i,0}=H(KWᵢ); h_{i,1}=H(h_{i,0}); kᵢ=H(R∥h_{i,0}); Tᵢ=(R∥h_{i,1}); cᵢ=SEₖ_{ᵢ}(kₘ) is calculated (where h_{i,0} indicates the value of the hash function for an i-th keyword KWᵢ, h_{i,1} indicates the value of the hash function for h_{i,0}, kᵢ indicates the value of the hash function when R and h_{i,0} are hashed together, Tᵢ indicates the value of the hash function when R and h_{i,1} are hashed together, and Cᵢ indicates a ciphertext when a symmetric key kₘ is encoded with a symmetric key kᵢ). Each of the clients 20 and 21 uses the hashed value of the keyword KW and the random number R to generate the symmetric key kᵢ for encoding the keyword kₘ that is secondarily hashed, and encodes the hashed keyword kₘ using the symmetric key kᵢ to generate the encoded keyword cᵢ.

(3) Each of the clients 20 and 21 uses a symmetric key encoding algorithm SE to encode the film m to be uploaded using the hashed keyword kₘ, thereby generating an encoded file c=SEₖ_{ₘ}(m).

(4) A ciphertext D=(R,c(T₁,c₁), . . . , (Tₙ,cₙ)) including the encoded keyword cᵢ generated in the process (2) and the encoded file c generated in the process (3) is uploaded to the file sharing server 10.

The file sharing server 10 stores the ciphertext D including the encoded file and the encoded keyword received from each of the clients 20 and 21 in the data table T.

The download protocol of the file sharing system is performed through processes (5) to (8).

Each of the clients 20 and 21 calculates h₀=H(KW); h₁=H(h₀) and transmits a query Q=hᵢ related to the keyword KW to the file sharing server 10, in order to download a file related to the keyword KW from the file sharing server 10.

The file sharing server 10 receives the query Q derived from the hashed keyword KW related to the file to be downloaded from each of the clients 20 and 21, and generates a set S_{D} of ciphertexts (a set of ciphertexts created from the keyword) from the ciphertexts D1, . . . , Dt stored in the data table using the following algorithm:

BeginAlgm {

S_{D} = Ø
For i = 1 to t

Dᵢ = (R,c,(T₁,c₁),...,(Tₙ,cₙ))
If H(R∥Q) = Tⱼ for some j∈[1,n], S_{D} = S_{D}υ{(R,

c,cⱼ)}

EndFor

The file sharing server 10 transmits the set S_{D} of ciphertexts created from the same keyword as that queried to the client 21.

The client 21 of a user terminal performs the following processes (5) to (8) in order to extract the file m from each ciphertext C=(R,c,cⱼ) in the set S_{D} of ciphertexts:

(5) The client 21 calculates h₀=H(KW) (where h₀ indicates the value of the hash function for the keyword KW);

(6) The client 21 calculates k=H(R∥h₀) (the value of the hash function, in which the random number R and h₀ are hashed together);

(7) The client 21 decodes the ciphertext cⱼ of the keyword from the relationship kₘ=SDₖ(cⱼ) using a symmetric key k through a symmetric key decoding algorithm S_{D}, thereby generating a decoded keyword kₘ; and

(8) The client 21 decodes the ciphertext c of the file m into a file (plaintext m) from the relationship m=SDₖ_{ₘ}(c) using the decoded symmetric key kₘ through the symmetric key decoding algorithm S_{D}.

Therefore, the file sharing server 10 performs a function of encoding/decoding files and keywords through the symmetric key algorithm as well as the function of a general file sharing system. According to this system, since the users are unable to recognize the content of files uploaded or downloaded, confidentiality is ensured, and the privacy of the users is also ensured. In addition, according to the above-mentioned structure, since only the symmetric key encoding algorithm is used, there is minute difference in the amount of computation between the above-mentioned structure and the related art.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A file sharing client system, comprising:
a keyword hashing unit that hashes keywords related to a file to be uploaded or downloaded;
a keyword encoder that encodes the keyword which is related to the file to be uploaded and is hashed by the keyword hashing unit, using a symmetric key algorithm;
a file encoder that uses the symmetric key algorithm to encode the file to be uploaded with the hashed keyword received from the keyword hashing unit; and
a first data transmitting/receiving unit that uploads, to a file sharing server, a ciphertext including the keyword encoded by the keyword encoder and the file encoded by the file encoder.

2. The file sharing client system of claim 1, further comprising:
a query requesting unit that outputs a query derived from the keyword that is related to the file to be downloaded and is hashed by the keyword hashing unit.

3. The file sharing client system of claim 2,
wherein the first data transmitting/receiving unit transmits the query received from the query requesting unit to the file sharing server, and downloads a set of ciphertexts from the file sharing server.

4. The file sharing client system of claim 3, further comprising:
a keyword decoder that decodes the keyword included in the set of ciphertexts using the symmetric key algorithm; and
a file decoder that decodes the encoded file included in the set of ciphertexts using the keyword decoded by the keyword decoder through the symmetric key algorithm.

5. The file sharing client system of claim 1,
wherein the keyword hashing unit secondarily hashes the keyword, and transmits the hashed keyword to the keyword encoder and the file encoder.

6. The file sharing client system of claim 2,
wherein the keyword hashing unit secondarily hashes the keyword, and transmits the hashed keyword to the query requesting unit.

7. A file sharing server system comprising:
a second data transmitting/receiving unit that receives, from a client, a ciphertext including an encoded file and an encoded keyword, and a query derived from a keyword related to a file to be downloaded, and transmits a set of ciphertexts to the client; and
a storage unit that stores the ciphertext received from the second data transmitting/receiving unit in a table.

8. The file sharing server system of claim 7, further comprising:
a query response processing unit that extracts, from the storage unit, the set of ciphertexts created from the same key as that related to the query received from the second data transmitting/receiving unit, and transmits the extracted set to the second data transmitting/receiving unit.

9. The file sharing server system of claim 8, further comprising:
a control unit that controls the second data transmitting/receiving unit, the storage unit, and the query response processing unit.

10. A file sharing method using encryption and decryption, the method comprising:
allowing a file sharing server to receive a ciphertext including an encoded file and an encoded keyword from a client;
allowing the file sharing server to store the ciphertext in a table of a storage unit; and
allowing the file sharing server to receive, from the client, a query derived from a keyword related to a file to be downloaded.

11. The file sharing method of claim 10, further comprising:
allowing the file sharing server to extract, from the storage unit, a set of ciphertexts created from the same keyword as that related to the received query, and transmit the extracted set to the client.

12. A file sharing method using encryption and decryption, the method comprising:
allowing a client to hash a keyword related to a file to be uploaded;
allowing the client to encode the hashed keyword using a symmetric key algorithm;
allowing the client to encode the file to be uploaded using the hashed keyword; and
allowing the client to upload a ciphertext including the encoded keyword and the encoded file to a file sharing server.

13. The file sharing method of claim 12, further comprising:
allowing the client to transmit, to the file sharing server, a query derived from a keyword related to a file to be downloaded.

14. The file sharing method of claim 13, further comprising:
allowing the client to download a set of ciphertexts from the file sharing server, decode the keyword included in the set of ciphertexts using the symmetric key algorithm, and decode the encoded file included in the set of ciphertexts using the decoded keyword through the symmetric key algorithm.

15. The file sharing method of claim 12,
wherein the uploading of the ciphertext includes:
selecting a random number R and a hashed keyword kₘ that is used as a symmetric key for encoding the file;
generating a symmetric key kᵢ for encoding the hashed keyword kₘ using the hashed value of a keyword KW and the random number R;
encoding the hashed keyword kₘ using the symmetric key kᵢ to generate an encoded keyword cᵢ;
encoding the file to be uploaded using the hashed keyword kₘ to generate an encoded file c; and
uploading the ciphertext including the encoded keyword cᵢ and the encoded file c to the file sharing server.

16. The file sharing method of claim 13,
wherein, in the transmitting of the query to the file sharing server, the keyword related to the file to be downloaded is secondarily hashed to derive the query.
